(19) United States
(12) Patent Application Publication
(10) Pub. No.: US 2025/0153440 A1
(43) Pub. Date: May 15, 2025

(54) RINSING STATION AND RINSING METHOD

(71) Applicant: ARBURG GMBH + CO KG, Lossburg (DE)

(72) Inventor: Rainer BLETSCHER, Baiersbronn (DE)

(21) Appl. No.: 18/681,187

(22) PCT Filed: Aug. 3, 2022
(86) PCT No.: PCT/EP2022/071885

§ 371 Date: Feb. 5, 2024

(30) Foreign Application Priority Data
Aug. 4, 2021 (DE) 10 2021 120 325.2

(51) Int. Cl. B29C 64/35; B33Y 40/00

(52) U.S. Cl. CPC B29C 64/35; B33Y 40/00

(57) ABSTRACT

The invention relates to a rinsing station and a method using at least one movable discharge unit for a device (1) for producing a three-dimensional object from a material which can be solidified in a construction area, said material being discharged out of the discharge unit in a rinsing process. The at least one discharge unit (2) used in the process comprises a discharge nozzle (12) and is moved into a rinsing position in order for the discharge nozzle (12) to be rinsed, and the discharge nozzle (12) of the discharge unit is placed on a closure component (10), which has at least one opening (11), of a disposal container (6). Fluid material which can be solidified is then discharged from the discharge unit (2) into the disposal container (6). The discharge nozzle (12) together with the discharge unit (2) is then separated from the closure component (10) of the disposal container (6), and the discharge unit (2) is then moved into a working position. In this manner, the production process is optimized and an optimal material quality is constantly provided at the outlet of the discharge unit while the service life of system-critical components is simultaneously increased.

### TECHNICAL FIELD

The disclosure relates to a flushing station comprising at least one movable discharge unit, and to a method for flushing at least one movable discharge unit using the flushing station, for a device for manufacturing a three-dimensional object from solidifiable material in a construction space, wherein in a working position the solidifiable material is dischargable from a discharge nozzle of the discharge unit, and wherein in a flushing position fluid solidifiable material is dischargable from the discharge unit in a flushing procedure.

### BACKGROUND

EP 1 886 793 A1, WO 2012/171647 A1 and WO 2013/017278 A1 disclose devices and methods by which three-dimensional objects are manufactured from solidifiable material in a construction space. In this context, materials that, under the action of elevated temperature, are either already a fluid in the starting condition or may be liquefied, are manufactured on an object support by the discharge of drops using at least one discharge unit with a discharge nozzle, wherein either the discharge unit and/or the object support is movable and as a result enables the sequential and additive deposition of fluid material on the object support. After it has been deposited on the object support, the material is then solidified by lowering the temperature, and in this way forms the three-dimensional object layer by layer. Comparable devices are known from the documents US 2017/0050388 A1, US 2019/0118258 A1 or US 2015/0343688 A1.

US 2020/061920 A1 discloses auxiliary material handling units for additive manufacturing (AM), methods for handling auxiliary material of an AM system and active print head cleaning devices. An auxiliary material handling unit (AMHU) comprises a material displacer having at least one inlet opening through which auxiliary material is received from an AM system, wherein the material displacer displaces the auxiliary material away from the at least one inlet opening. A method of handling auxiliary material of an AM system comprises receiving auxiliary material from the AM system in a material displacer having at least one inlet opening, wherein the material displacer displaces the auxiliary material away from the at least one inlet opening. The displaced auxiliary material can be collected in a collection container. An active printhead cleaning device actively cleans auxiliary material from an AM printhead and feeds the auxiliary material to an AMHU. An AM process utilizing multiple printheads includes applying material with a first printhead to produce a part, wherein auxiliary material is deposited with a second printhead during the application of material with the first printhead. The deposited auxiliary material can be received and displaced by a material displacer having at least one inlet opening.

However, in the case of the known devices and methods, it is in particular disadvantageous that if there are relatively long pauses during the manufacturing procedure the materials used may undergo thermal damage. So that material is not embedded in the object in the course of the manufacturing procedure, possibly thus impairing the appearance and also material-specific properties, in standard practice today two methods are employed to discharge material or indeed where appropriate degraded material from the discharge unit and in particular from its discharge nozzle. On the one hand, material may be flushed out of the discharge unit into a waste region inside or outside the construction space until freshly melted material is once again available at the discharge nozzle. On the other, material may be incorporated into a sacrificial object in order not to exceed the dwell time of the critical material in the discharge unit. The incorporation of material in the sacrificial object is timed such that as far as possible no degraded material is produced, because the material is not subjected to a high temperature for too long.

Both solutions are used in commercially available devices and methods, but have the disadvantage that material is merely discharged, and there is no simultaneous action to prevent the possibility that system-critical components such as the discharge nozzle will get dirty, as a result of which the service life of these components is shortened. Residual material from the discharge nozzle may reach the structural part, which in turn may impair its material-specific properties and appearance. At least in the case of the sacrificial-object method, moreover, there is a greater consumption of material, which increases the construction time, as a result of which production costs also rise.

### BRIEF SUMMARY

The disclosure provides a flushing station comprising at least one movable discharge unit, and a method for flushing at least one movable discharge unit using the flushing station, for a device for manufacturing a three-dimensional object from solidifiable material in a construction space, by which the manufacturing procedure is optimized and in which material is always provided at the output of the discharge unit, while at the same time lengthening the service life of system-critical components.

The flushing station comprises:
a first movement mechanism that is integrable in the device, configured for transferring the discharge unit to the flushing position,
a disposal container that is movable in the device, and a closure component connectable thereto,
a second movement mechanism that is integrable in the device, configured for connecting the disposal container to the closure component comprising at least one opening and for subsequently applying the discharge nozzle to the opening in the closure component,
a controller that is separate from a controller of the device and communicates with the controller of the device or is integrable therein, configured for controlling the transfer of the discharge unit to the flushing position using the first movement mechanism, for connecting the closure component comprising the at least one opening to the disposal container, and for subsequently applying the discharge nozzle to the opening in the closure component using the second movement mechanism, for discharging fluid solidifiable material, wherein the connection of the closure component to the disposal container and the application of the discharge nozzle to the opening in the closure component are configured to generate a thermally optimized condition or a condition achieved by pressure in the disposal container that reduces a volume of the discharged fluid solidifiable material, for separating the discharge nozzle from the opening in the closure component of the disposal container, and for transferring the discharge unit to a working position,
wherein the discharge nozzle and the opening in the closure component have a mutually adapted geometry with a conical shape of the discharge nozzle and the opening, respectively, which geometry is configured to reduce the adhesion of discharged material to the discharge nozzle and to enable the discharge nozzle to be separated from the closure component in a manner that is to the greatest possible extent free of strands.

The method comprises the steps:
transferring the discharge unit to the flushing position,
connecting a disposal container to a closure component comprising at least one opening,
applying the discharge nozzle to the opening in the closure component,
discharging fluid solidifiable material from the discharge unit, wherein preferably because the discharge nozzle is connected to the opening in the closure component a thermally optimized condition or a condition achieved by pressure is brought about in the disposal container as a result of which large-volume accumulations of strands are melted to give minimal plugging,
separating the discharge nozzle of the discharge unit from the opening in the closure component of the disposal container, wherein a mutually adapted geometry with a conical shape, of the discharge nozzle of the discharge unit and the opening in the closure component, respectively, reduces the adhesion of discharged material to the discharge nozzle and separates the discharge nozzle from the closure component in a manner that is to the greatest possible extent free of strands, and
transferring the discharge unit to a working position,
   wherein the steps are carried out in the order mentioned.

The flushing station and the method have the advantages that the discharge nozzle of the discharge unit is kept in a condition that is well suited to manufacture throughout the manufacturing procedure of the object or objects. Thus, any desired change of material is possible at any time during production, as a result of which delays in manufacture are avoided. Moreover, it is also possible to dispose of at least partly degraded material as required, in order to avoid or prevent an undesired quality of material and hence also disruptions to the quality of the object or objects. At the same time, the quality of the material to be processed can be enhanced. However, it is fundamentally possible to change material at any time by flushing the discharge unit.

Where necessary, the temperature of the discharged material can be influenced such that it is discharged for example at a predetermined temperature in order to optimize or preferably reduce the volume occupied by the material that is discharged or to be disposed of. This has the advantage, from an environmental point of view, of a smaller volume of bulk to be disposed of.

With the preferred use of a plurality of discharge units, the controller is configured to enable, advantageously simultaneously, manufacture of the three-dimensional object using at least one discharge unit in the construction space, and discharge to the disposal container of the fluid solidifiable material, which where appropriate may also already be partly degraded, using at least one discharge unit. As a result, advantageously both the construction time of the objects and the dwell time of the material may be reduced.

A first embodiment of the flushing station, which is advantageous for the service life of the overall system and for the material-specific properties of the material discharged during the construction procedure, provides for material that still adheres to the discharge nozzle to be separated from the disposal container at the same time as the discharge nozzle is separated from the opening in the closure component of the disposal container. This advantageously contributes to the quality of the material in the object and hence to the quality of the manufactured objects.

An embodiment of the flushing station that is advantageous for the productivity of the overall system, for shortening the manufacturing time, provides for the first movement mechanism to be configured for removing the discharge unit from the construction space and, after the fluid solidifiable material has been discharged outside the construction space, for introducing the discharge unit into the construction space.

An embodiment of the flushing station that is advantageous for the productivity and cost efficiency of the overall system provides for the closure component to have a plurality of openings and to be configured to enable multiple discharge of fluid solidifiable material into the disposal container. Advantageously, this additionally reduces the construction times of the objects to be manufactured.

Further embodiments of the flushing station that are advantageous for the productivity and cost efficiency of the overall system provide for a plurality of disposal containers to be stored in a container magazine that is integrable into the device. Using a separation unit that is integrable into the device, the disposal containers are configured to be individually separated out and transferred to a disposal container receptacle that is connected to a carrier arm arranged on a pivotal and linear movement mechanism which is integrable into the device, wherein the second movement mechanism comprises the pivotal and linear movement mechanism. As a result, the disposal is advantageously optimized in terms of both time and quantity.

An additional embodiment of the flushing station that is advantageous for functioning and for the productivity and cost efficiency of the overall system provides for the closure component to be integrated into the disposal container receptacle.

An embodiment of the flushing station that is advantageous for functioning and for the productivity and cost efficiency of the overall system preferably provides for the first movement mechanism to comprise a lifting-away mechanism that forms a free space below the discharge nozzle which makes it possible, with the pivotal and linear movement mechanism, to position the disposal container in different positions below the discharge nozzle that correspond to the number of openings in the closure component.

An embodiment of the flushing station that is advantageous for the operation and maintainability of the overall system preferably provides for the pivotal and linear movement mechanism to be configured to be arranged on a pivotal covering lid of the device.

An additional embodiment of the flushing station that is advantageous for the productivity and cost efficiency of the overall system preferably provides for completely full disposal containers to be transportable, using the pivotal and linear movement mechanism, to a disposal arrangement that is connected to the device.

An embodiment of the flushing station and the method that is advantageous for the service life of the overall system and for the material-specific properties of the material that is discharged during the construction procedure provides for discharged material that remains on the discharge nozzle to be stripped off at the same time as the discharge nozzle of the discharge unit is separated from the opening in the closure component of the disposal container.

An embodiment of the method that is advantageous for the productivity and cost efficiency of the overall system provides, when a closure component having a plurality of openings is used, for multiple discharge of fluid solidifiable material to the disposal container to be carried out.

According to the method, when a plurality of discharge units is used, manufacture of the three-dimensional object using at least one discharge unit in the construction space and discharge of the fluid solidifiable material using at least one discharge unit in the flushing position may advantageously be performed simultaneously.

### BRIEF DESCRIPTION OF THE FIGURES

The disclosure is now explained in more detail with reference to exemplary embodiments. In the drawings:

FIG. 1 shows a perspective view of a device for manufacturing a three-dimensional object from solidifiable material in a construction space, with three discharge units and a flushing station,

FIG. 2 shows a perspective detail view of a detail A from FIG. 1,

FIG. 3 shows a perspective detail view of the device from FIG. 1, with three discharge units and a pivotal and linear movement mechanism,

FIG. 4 shows a perspective detail view of the device from FIG. 1, with a pivotal and linear movement mechanism, a carrier arm with a disposal container receptacle, and a container magazine,

FIG. 5 shows a perspective detail view of a detail B from FIG. 4, with the carrier arm with disposal container receptacle and, connected thereto, closure component,

FIG. 6 shows a perspective detail view of the detail B from FIG. 4, with the carrier arm with disposal container receptacle and the closure component connected thereto, disposal container and discharge unit with discharge nozzle, and

FIG. 7 shows a perspective detail and sectional view of the detail B from FIG. 4, with the carrier arm with disposal container receptacle and the closure component connected thereto, disposal container and discharge nozzle.

### DETAILED DESCRIPTION

Before the disclosure is described in detail it should be pointed out that it is not restricted to the respective structural parts of the device and the respective method steps, since these structural parts and method may vary. The terms used here are merely intended to describe particular embodiments and are not used restrictively. Moreover, where the singular or the indefinite article is used in the description or the claims, this also refers to a plurality of these elements unless the overall context unambiguously indicates otherwise.

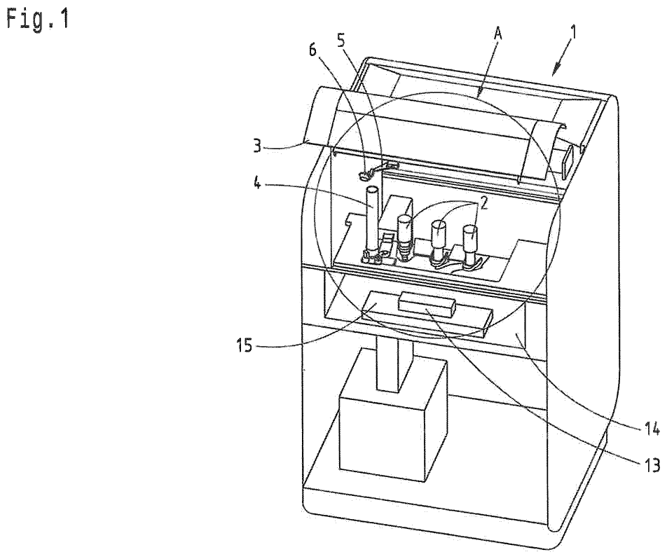

FIG. 1 shows a device 1 for manufacturing a three-dimensional object 13 from solidifiable material in a construction space 14. In this context, materials that, under the action of elevated temperature, are either already a fluid in the starting condition or may be liquefied, are manufactured on an object support 15 by the discharge of drops using at least one discharge unit 2 with a discharge nozzle 12, wherein the object support 15 is arranged below the discharge unit 2, wherein either the discharge unit 2 and/or the object support 15 is movable and as a result enables the sequential and additive deposition of fluid material on the object support 15. After it has been deposited on the object support 15, the material is then solidified, for example by lowering the temperature, and in this way forms the three-dimensional object 13 layer by layer.

The device 1 may also be able, besides the dropwise discharge of the material, to discharge it from the discharge unit 2 in strand form as well.

The device 1 illustrated in FIG. 1 has three discharge units 2, each of which may be in a working position or flushing position, and which are configured, in the working positions, to enable either a selective discharge of material through one discharge unit 2 or a simultaneous discharge through a plurality of discharge units 2, downward into the construction space 14 (which is not designated or illustrated in more detail) and onto one or more object supports 15 (which are not designated or illustrated in more detail) located there. Where required, it is also possible to discharge a support material through one of the discharge units 2.

Also illustrated are parts of a flushing station, such as a carrier arm 5 and a disposal container 6, which may be arranged for example on a pivotal covering lid 3 of the device 1 and which, in a flushing procedure, serve to discharge fluid solidifiable material from a discharge unit 2 that is in a flushing position, into disposal containers 6 that may themselves be temporarily stored in a container magazine 4 before they are used. As a result of corresponding dwell times or external influences such as a particular temperature characteristic in the construction space, the fluid solidifiable material may be at least partly degraded, but need not be. Fundamentally, a simple desire to change material is for example also sufficient for a disposal of material where appropriate.

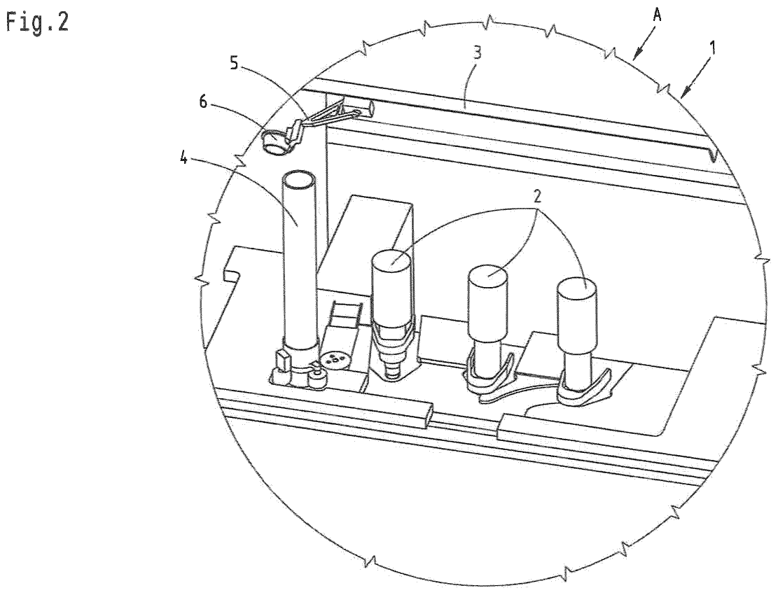

FIG. 2 shows a perspective detail view of a detail A from FIG. 1. In addition to the three discharge units 2, also visible here are the container magazine 4 for the disposal containers 6 into which fluid solidifiable material is dischargable, and the pivotal covering lid 3, on which the parts of the flushing station already mentioned above may be arranged.

The illustrated parts are a carrier arm 5, which is securable to a pivotal and linear movement mechanism 8, and a disposal container 6 for discharged material, which is connectable to the carrier arm 5. An arrangement of the pivotal and linear movement mechanism 8 with the carrier arm 5 on the pivotal covering lid 3 of the device 1 has the advantage that the whole set-up may be pivoted upward, for example in the event of servicing, in order to ensure optimal access for example to the discharge units 2 by servicing personnel. Another arrangement, inside the device 1, is likewise possible.

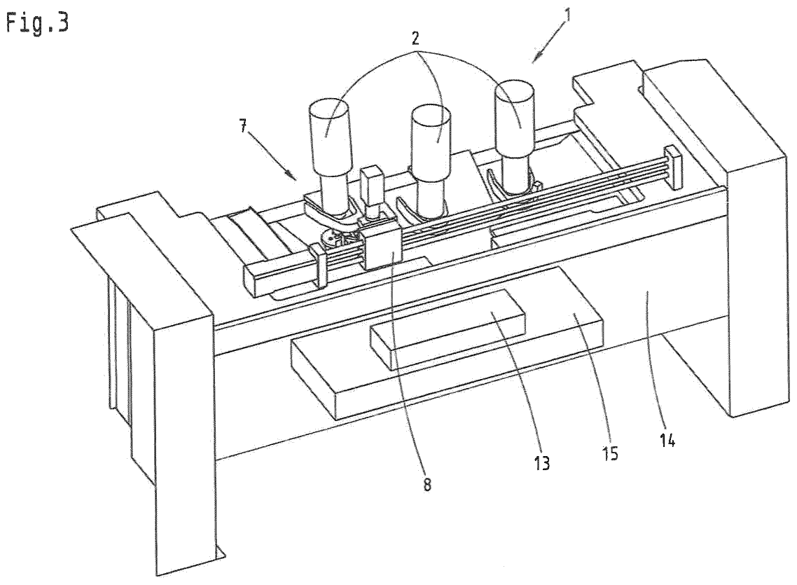

FIG. 3 illustrates a perspective detail view, from the front, of the device from FIG. 1, with three discharge units 2 and the pivotal and linear movement mechanism 8, which is illustrated without the pivotal covering lid 3 on which it is configured to be arranged. The discharge units 2 may be mounted in a lifting-away mechanism 7 that makes it possible to lift or move the discharge units 2 out of their working position in the construction space 14 and into the flushing position, if a transfer out of the construction space 14 is desired. This makes it easier to position a disposal container 6 below the discharge unit 2, in particular below its discharge nozzle 12, wherein the disposal container 6 can be positioned below the discharge unit 2 that is in the flushing position using the carrier arm 5 to which it is securable, and using the pivotal and linear movement mechanism 8, which is configured to be arranged on the pivotal covering lid 3 of the device 1.

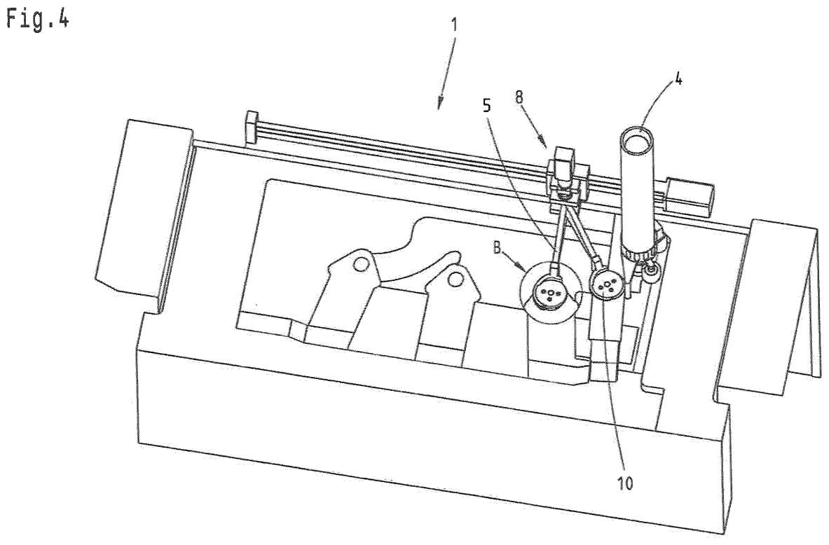

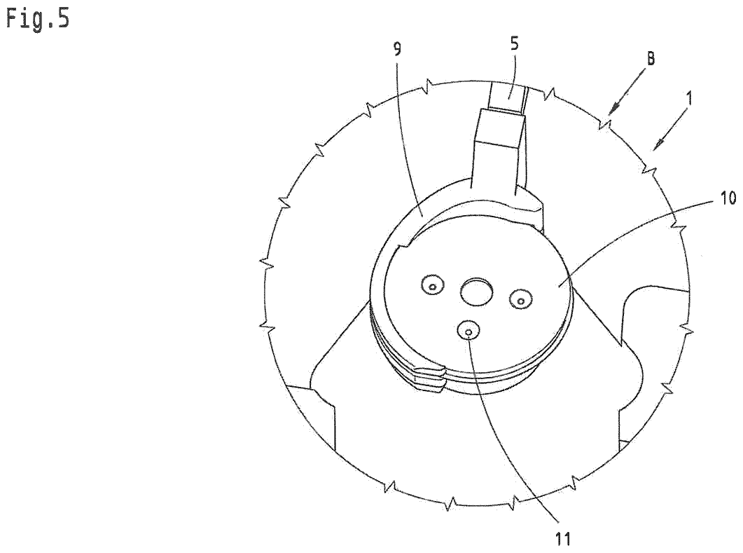

FIG. 4 shows a further perspective detail view, from the rear, of the device from FIG. 1, without the discharge units 2 and with the pivotal and linear movement mechanism 8 and the carrier arm 5 arranged thereon. The other end of the carrier arm 5 is connectable to a closure component 10, which covers the disposal container 6 (not illustrated here). The connection between the closure component 10 and the disposal container 6 may be made for example using a disposal container receptacle 9 (FIG. 5), which is directly connectable to the end of the carrier arm 5 and holds the closure component 10 and the disposal container 6 that is connected thereto, and where appropriate connects them to one another. In the latter case, the connection may be made for example by pressing the two components together. However, it may also be that the connection between the closure component 10 and the disposal container 6 is made for example by a screw or bayonet closure or by a force-locking connection, wherein the connected parts are only held by the disposal container receptacle 9. Likewise, the closure component 10 may be integrated into the disposal container receptacle 9.

Also schematically illustrated is the taking up of the disposal container 6 from the container magazine 4, which has a separation unit (not illustrated in more detail) for individually separating the disposal containers 6 out of the container magazine 4 and transferring them to the carrier arm 5, which receives the disposal container 6 from the transferring separation unit and positions them directly below the discharge unit 2 (not illustrated).

FIG. 5 illustrates a perspective detail view of a detail B from FIG. 4, with the carrier arm 5 and, connected thereto, the disposal container receptacle 9 and, connected thereto, the closure component 10. As illustrated, the closure component 10 may have three openings 11, which enable multiple discharge of for example at least partly degraded fluid solidifiable material from the discharge unit 2. Fundamentally, however, it is also possible for more or fewer than three openings 11 to be provided. Using multiple discharge, it is possible to utilize the disposal containers 6 efficiently.

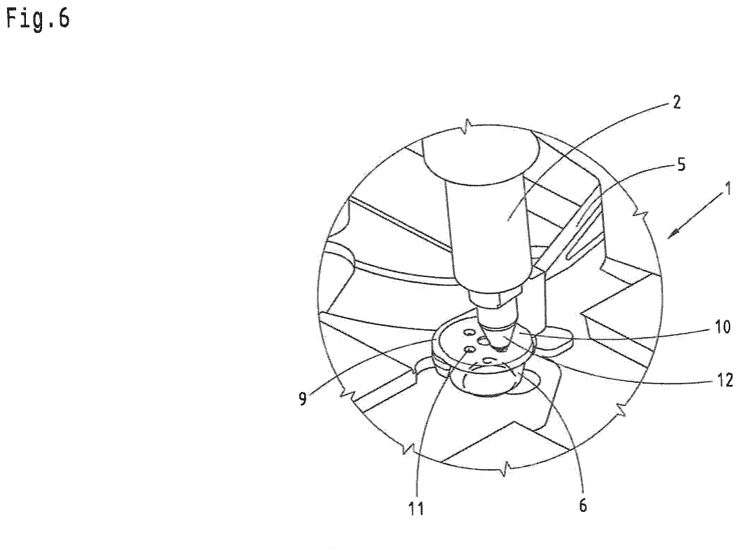

FIG. 6, a further perspective detail view of the detail B from FIG. 4, shows further details of the flushing station. Shown here is the carrier arm 5 with disposal container receptacle 9 and, connected thereto, the further parts of the flushing station: the closure component 10, the disposal container 6, the discharge unit 2, and the discharge nozzle 12 thereof, wherein the discharge nozzle 12 of the discharge unit 2 is applied to the opening 11 in the closure component 10 and the disposal container 6 connected thereto.

Furthermore illustrated are the three openings 11 in the closure component 10, wherein the pivotal and linear movement mechanism 8 makes it possible to position each of the openings 11 in the closure component 10 below the discharge nozzle 12. Once the material has been discharged into the disposal container 6, the discharge nozzle 12 is separated from the opening 11 in the closure component. Advantageously, in so doing discharged material that remains can be stripped off the discharge nozzle 12 at the same time, and this can additionally improve its functionality.

Since the fluid solidifiable material is discharged for example at a predetermined material temperature, it is possible, as a result of the connection between the discharge nozzle 12, closure component 10 and disposal container 6, to produce a preferably thermally optimized condition in the disposal container 6 that results in minimizing the volume of the discharged material. However, a condition of this kind may also be achieved in a different manner, for example by pressure or chemical additives. As a result, the large-volume accumulations of strands that are usually produced during discharge are melted to give minimal plugging, as a result of which it becomes possible to carry out multiple discharge using the plurality of openings 11 in the closure component 10, ensuring, where required, efficient and cost-effective repeated utilization of the disposal containers.

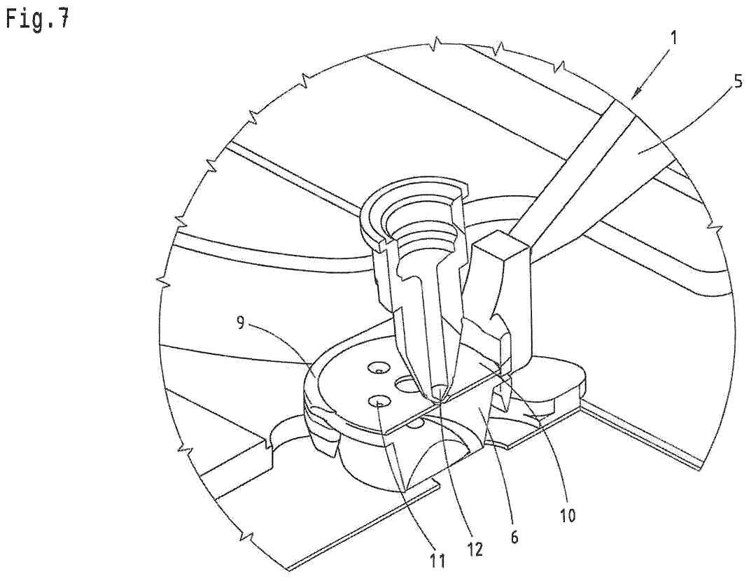

FIG. 7 is a further perspective detail and sectional view, partly in section and analogous to the detail B from FIG. 4, with the carrier arm 5 with disposal container receptacle 9 and closure component 10 connected thereto, disposal container 6 and discharge nozzle 12, with the discharge unit 2 not illustrated.

Readily visible in this illustration of an advantageous embodiment of the flushing station is the particular, mutually adapted geometry of the discharge nozzle 12 and the openings 11 in the closure component 10, which additionally contributes to reducing adhesion to the discharge nozzle and hence makes it possible to separate the discharge nozzle 12 from the opening 11 in the closure component 10 in a manner that is to the greatest possible extent free of strands. In the illustrated case, this is a conical shape in each case. However, it may be of any other mutually adapted geometric shape that is suitable for reducing the adhesion of discharged material to the discharge nozzle 12 and hence makes it possible to separate the discharge nozzle from the opening 11 in the closure component 10 in a manner that is to the greatest possible extent free of strands. This avoids additional cleaning steps for cleaning the discharge nozzle 12, as a result of which the efficiency of the device 1 is improved.

Fundamentally, at the same time as the discharge nozzle 12 is separated from the opening 11 in the closure component 10, in particular while these structural parts are cooperating, it is also possible to separate off material that is still adhering to the discharge nozzle at the disposal container 6. Excess or adhering material, in particular material that is no longer needed or is for example degraded, may in this way be transferred from the discharge nozzle 12 to the disposal container 6.

Advantageously, the flushing station may be used, simultaneously with manufacture of the three-dimensional object 13 using at least one discharge unit 2 that is located in the construction space 14 and hence in the manufacturing procedure, to clean at least one discharge unit 2, in particular the discharge nozzle 12 thereof, that is in the flushing position and where appropriate outside the construction space 14, and thus not in the manufacturing procedure. This additionally shortens manufacture of the three-dimensional objects.

Disposal containers 6 that are completely full of discharged material may be transported, using the pivotal and linear movement mechanism 8, to a disposal arrangement that is connected to the device 1, and disposed of there. The disposal containers 6 may be disposed of, by way of a guide track connected to the device 1, to an external collection point, which may in turn be emptied in a manner independent of the procedure.

A method for flushing at least one movable discharge unit 2 for a device 1 for manufacturing a three-dimensional object 13 from solidifiable material in a construction space 14, in which fluid solidifiable material is discharged from the discharge unit 2 in a flushing procedure using the flushing station, may comprise the following steps:
transferring the discharge unit 2 to the flushing position,
connecting a disposal container 6 to a closure component 10 having at least one opening 11,
applying a discharge nozzle 12 of the discharge unit 2 to the opening 11 in the closure component 10,
discharging fluid solidifiable material from the discharge unit 2, wherein because the discharge nozzle 12 is connected to the opening 11 in the closure component 10 a thermally optimized condition or a condition achieved by pressure is brought about in the disposal container 6 as a result of which a volume of the discharged fluid solidifiable material is reduced,
separating the discharge nozzle 12 of the discharge unit 2 from the opening 11 in the closure component 10 of the disposal container 6, wherein a mutually adapted geometry with a conical of the discharge nozzle 12 of the discharge unit 2 and the opening 11 in the closure component 10, respectively, reduces the adhesion of discharged material to the discharge nozzle 12 and separates the discharge nozzle 12 from the closure component 10 in a manner that is to the greatest possible extent free of strands, and
transferring the discharge unit 2 to the working position,
   wherein the steps are carried out in the order mentioned.

If in this context a plurality of discharge units 2 is where appropriate used at the same time, it is in addition possible to carry out manufacture of the three-dimensional object 13 using at least one discharge unit 2 in the construction space 14, and discharge of the fluid solidifiable material using at least one discharge unit 2 in the flushing position.

For this purpose, a discharge unit 2 which is ready to be cleaned is removed from the manufacturing procedure, that is to say for example from the construction space, while another discharge unit 2 continues with the manufacturing procedure. The removed discharge unit 2 is flushed and/or cleaned in a manner corresponding to the explanation above, and is then put back into the construction space 14. In this way, all the discharge units 2 of the device 1 can be flushed one after the other, as a result of which there is no loss of time resulting from a consecutive sequence of the manufacturing procedure and the flushing procedure, in the manner known from the prior art.

Preferably, when the discharge nozzle 12 of the discharge unit 2 is separated from the opening 11 in the closure component 10 of the disposal container 6, it is possible to strip off discharged material that remains on the discharge nozzle 12 at the same time, which additionally lengthens the service life of the discharge nozzle 12 and improves the material-specific properties of the material that is discharged in the construction space.

Moreover, when a closure component 10 having a plurality of openings 11 is used, multiple discharge of fluid solidifiable material into the disposal container 6 can be carried out, as a result of which efficient and cost-effective repeated utilization of the disposal containers is ensured.

1. A flushing station comprising at least one movable discharge unit for a device for manufacturing a three-dimensional object from solidifiable material in a construction space,
wherein in a working position the solidifiable material is dischargable from a discharge nozzle of the discharge unit, and
wherein in a flushing position the fluid solidifiable material is dischargable from the discharge unit in a flushing procedure,
wherein the flushing station comprises:
a first movement mechanism configured to be integrable in the device and for transferring the discharge unit to the flushing position,
a disposal container movable in the device, and a closure component connectable thereto,
a second movement mechanism configured to be integrable in the device and for connecting the disposal container to the closure component comprising at least one opening and for subsequently applying the discharge nozzle to the opening in the closure component,
a controller configured to communicates with a controller of the device and configured for
controlling a transfer of the discharge unit to the flushing position using the first movement mechanism,
connecting closure component comprising the at least one opening to the disposal container, and
subsequently applying the discharge nozzle to the at least one opening in the closure component using the second movement mechanism, for discharging fluid solidifiable material, wherein the connection of the closure component to the disposal container and the application of the discharge nozzle to the opening in the closure component are configured to generate a thermally optimized condition or a condition achieved by pressure in the disposal container, the condition reducing a volume of a discharged fluid solidifiable material,
for separating the discharge nozzle from the opening in the closure component of the disposal container, and
for transferring the discharge unit to the working position,
wherein the discharge nozzle and the at least one opening in the closure component have a mutually adapted geometry with a conical shape of the discharge nozzle and the opening, respectively, which geometry is configured to reduce the adhesion of discharged material to the discharge nozzle and to enable the discharge nozzle to be separated from the closure component in a manner that is free of strands.

2. The flushing station as claimed in claim 1, wherein, when a plurality of discharge units is used, the controller is configured to enable, simultaneously, manufacture of the three-dimensional object using at least one discharge unit in the construction space, and discharge of the fluid solidifiable material to the disposal container using at least one other discharge unit.

3. The flushing station as claimed in claim 1, wherein the flushing station is configured to separate discharged material that remains at the disposal container at the same time as the discharge nozzle is separated from the opening in the closure component of the disposal container.

4. The flushing station as claimed in claim 1, wherein the first movement mechanism is configured for removing the discharge unit from the construction space and, after the fluid solidifiable material has been discharged outside the construction space, for introducing the discharge unit into the construction space.

5. The flushing station as claimed in claim 1, wherein the closure component comprises a plurality of openings and is configured to discharge a plurality of fluid solidifiable materials into the disposal container.

6.-7. (canceled)

8. The flushing station as claimed in claim 1, wherein a plurality of disposal containers is provided and stored in a container magazine integrable into the device.

9. The flushing station as claimed in claim 8, wherein, using a separation unit, the disposal containers are configured to be individually separated out and transferred to a disposal container receptacle connected to a carrier arm arranged on a pivotal and linear movement mechanism, wherein the second movement mechanism comprises the pivotal and linear movement mechanism.

10. The flushing station as claimed in claim 9, wherein the closure component is integrated into the disposal container receptacle.

11. The flushing station as claimed in claim 9, wherein the first movement mechanism comprises a lifting-away mechanism that forms a free space below the discharge nozzle which is configured, with the pivotal and linear movement mechanism, to position the disposal container in different positions below the discharge nozzle which positions correspond to the number of openings in the closure component.

12. The flushing station as claimed in claim 9, wherein the pivotal and linear movement mechanism is configured to be arranged on a pivotal covering lid of the device.

13. A method for flushing at least one movable discharge unit for a device for manufacturing a three-dimensional object from solidifiable material in a construction space, wherein in a working position the solidifiable material is discharged from a discharge nozzle of the discharge unit, and
wherein in a flushing position fluid solidifiable material is discharged from the discharge unit in a flushing procedure, using a flushing station corresponding to claim 1,
comprising the steps:
transferring the discharge unit to the flushing position,
connecting a disposal container to a closure component comprising at least one opening,
applying the discharge nozzle to the opening in the closure component
discharging the fluid solidifiable material from the discharge unit, wherein preferably-because the discharge nozzle is connected to the at least one opening in the closure component a thermally optimized condition or a condition achieved by pressure is generated in the disposal container as a result of which a volume of the discharged fluid solidifiable material is reduced,
separating the discharge nozzle of the discharge unit from the at least one opening in the closure component of the disposal container, wherein a mutually adapted geometry with a conical shape of the discharge nozzle of the discharge unit and the opening respectively, reduces the adhesion of discharged material to the discharge nozzle and separates the discharge nozzle from the closure component in a manner that is free of strands, and
transferring the discharge unit to the working position,
wherein the steps are carried out in the order mentioned.

14. The method as claimed in claim 13, wherein, when a plurality of discharge units is used, manufacture of the three-dimensional object using at least one discharge unit in the construction space and discharge of the fluid solidifiable material using at least one other discharge unit in the flushing position is performed simultaneously.

15. The method as claimed in claim 13, wherein discharged material that remains on the discharge nozzle is stripped off at the same time as the discharge nozzle of the discharge unit is separated from the opening in the closure component of the disposal container.

16. The method as claimed in one of claim 13, wherein, when a closure component comprising a plurality of openings is used, multiple discharge of fluid solidifiable material to the disposal container is carried out.

17. (canceled)
